(19) United States
(12) Patent Application Publication
(10) Pub. No.: US 2020/0313919 A1
(43) Pub. Date: Oct. 1, 2020

(54) ENGAGEMENT LEVELS IN ONLINE CONFERENCES

(71) Applicant: Lenovo (Singapore) Pte. Ltd., Singapore (SG)

(72) Inventors: Coby Rick Gurr, South Jordan, UT (US); Daniel John Verwolf, Ada, MI (US); Timothy Robbins, Avon, IN (US); Haiyan Feng, JR., Shen Zhen (CN)

(21) Appl. No.: 16/369,151

(22) Filed: Mar. 29, 2019

(51) Int. Cl. H04L 12/18

(52) U.S. Cl. CPC H04L 12/1831; H04L 12/1822

(57) ABSTRACT

One embodiment provides a method, including: automatically segmenting, without additional user input, an online conference into one or more sections; identifying, using a processor, an engagement level for each of the one or more sections in the online conference; and formulating, based on the identifying, a report. Other aspects are described and claimed.

### BACKGROUND

Web conference groups are frequently formed to facilitate real-time discussion between two or more individuals. These online conferences are popular in the professional world and may operate similar to in-person conference meetings in that they allow topics to be discussed between multiple people simultaneously. Additionally, online conferencing provides the added benefit of connecting individuals positioned in geographically diverse locations. Common applications for online conferencing include meetings, training events, lectures, presentations, and the like.

### BRIEF SUMMARY

In summary, one aspect provides a method, comprising: segmenting an online conference into one or more sections; identifying, using a processor, an engagement level for each of the one or more sections; and formulating, based on the identifying, a report.

Another aspect provides an information handling device, comprising: a processor; a memory device that stores instructions executable by the processor to: segment an online conference into one or more sections; identify an engagement level for each of the one or more actions; and formulate, based on the identifying, a report.

A further aspect provides a product, comprising: a storage device that stores code, the code being executable by a processor and comprising: code that segments an online conference into one or more sections; code that identifies an engagement level for each of the one or more sections; and code that formulates, based on the identifying, a report.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of segmenting a conference into sections and identifying an engagement level in each section.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Unlike conventional conferences where attendees have face-to-face interactions with each other, attendees in online conferences generally communicate through one or more devices. For example, a plurality of attendees using web-connected devices (e.g., laptops and/or personal computers, smartphones, tablets, etc.) may connect to an online conference room (e.g., hosted on a conferencing application, a website, etc.) where communication between the attendees may be facilitated via inputs (text inputs, voice inputs, video inputs, etc.) to their devices.

The absence of in-person communication may make it difficult to analyze how well certain aspects of a web presentation were received by an online audience. More particularly, presenters delivering content to a live, face-to-face audience may be able to directly gauge the attendees' receptiveness and emotional reactions to certain portions of their presentation. However, in online conferences it is nearly impossible to obtain an accurate handle on what is going on with the attendees. Although detection tools exist that may monitor an attendees' interactivity with their device, these tools cannot be used in a logical manner to improve content delivery. A consequence of this is that a presenter must remember which parts of their presentation “felt” disengaging and attempt to adapt in future presentations. Remembering all of this while still trying to deliver an engaging presentation may be stressful to a presenter and may decrease the overall quality of the conference.

Accordingly, an embodiment provides a method for dynamically segmenting a conference presentation into different sections and thereafter reporting on the engagement levels within each section. In an embodiment, an online conference may be segmented into one or more sections. The segmenting may be conducted based upon various parameters (e.g., by conference slides, identified topics, time intervals, user interactions, etc.). An embodiment may then identify an engagement level for each of the sections and thereafter generate a report based on these identifications. In an embodiment, the report may be presented to a user in various ways and may comprise a variety of different types of information related to the engagement levels in each section. Such a method may allow a system to learn about a conference leader's presenting habits and identify what effects those habits may have on the engagement levels of conference attendees.

The illustrated example embodiments will be best understood by reference to the figures. The following description is intended only by way of example, and simply illustrates certain example embodiments.

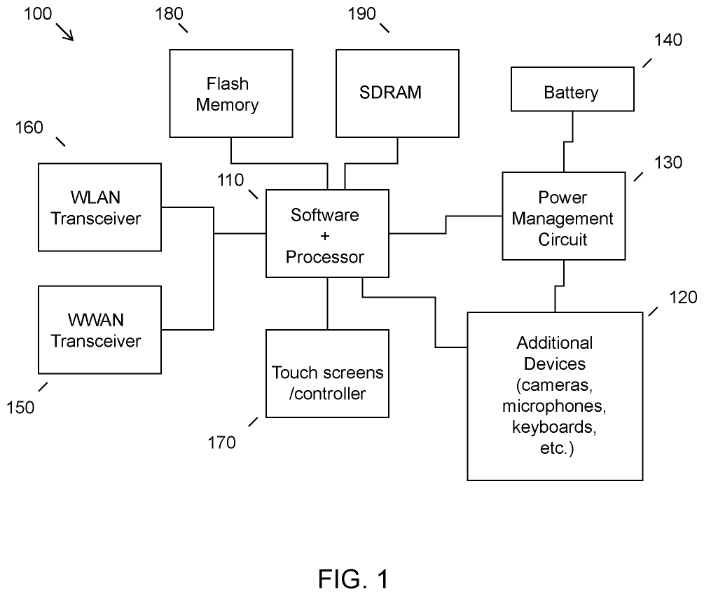

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, external keyboard, other input devices, etc. System 100 often includes one or more touch screens 170 for data input and display/rendering. System 100 also typically includes various memory devices, for example flash memory 180 and SDRAM 190.

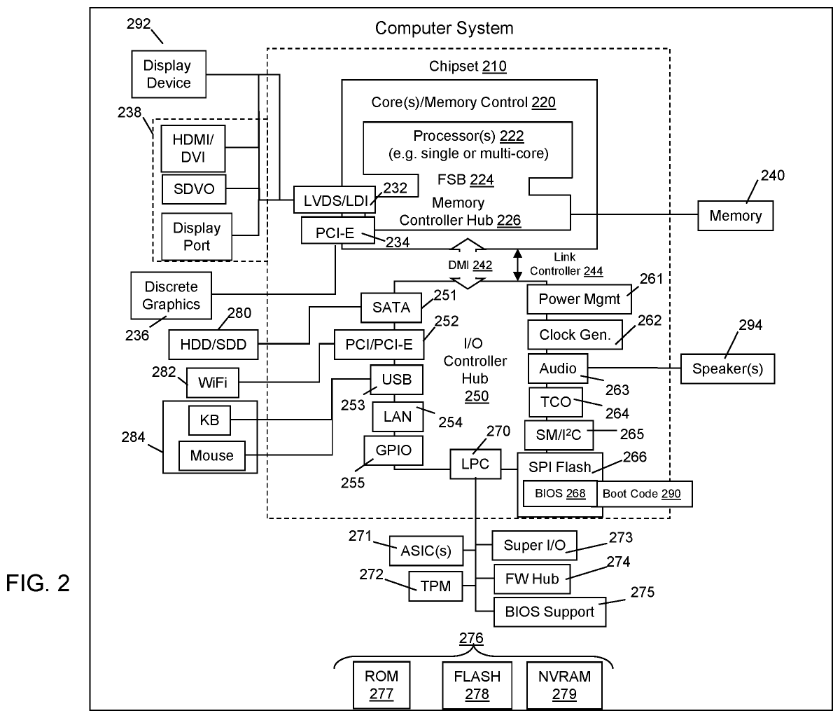

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops, personal computer devices generally, and/or other electronic devices that may be capable of engaging in online conference applications. For example, the circuitry outlined in FIG. 1 may be implemented in a tablet or smart phone embodiment, whereas the circuitry outlined in FIG. 2 may be implemented in a laptop.

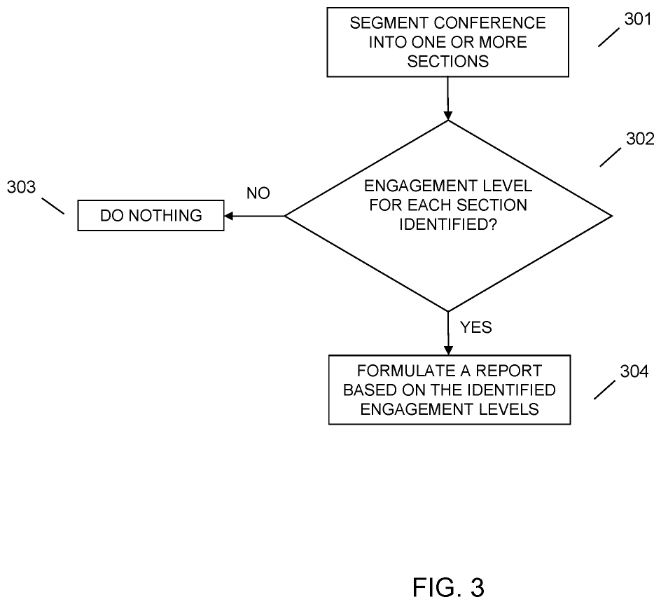

Referring now to FIG. 3, an embodiment may identify engagement levels for dynamically segmented sections of an online conference and thereafter generate a report, for user review, elaborating on these engagement levels. At 301, an embodiment may segment an online conference into one or more sections. In the context of this application, a section may refer to an intelligently sliced portion of the online conference. This portion may not be visible to attendees nor may attendees be notified that a particular section exists or is changing. In an embodiment, the segmenting may be done automatically, without additional user input, and may be based on one or more segmenting criteria further described below.

In an embodiment, the online conference may be segmented based upon slides used in the online conference. More particularly, if a conference leader or presenter utilizes a slide-based presentation to share their content, each slide in the presentation may be considered a section. In another embodiment, the online conference may be segmented based upon the topics presented or discussed in the conference. In this situation, an embodiment may utilize one or more conventional conversation analysis techniques to identify a topic/a shift in topics. For example, an embodiment may identify a phrase spoken by the conference leader that is indicative of a topic, “Alright, let's start off the conversation by talking about X”. Additionally or alternatively, an embodiment may identify that the discussion has focused on a particular subject for a predetermined period of time (e.g., 5 minutes, 10 minutes, etc.). In yet another embodiment, the online conference may be segmented based upon a predetermined time interval (e.g., 1 minute, 5 minutes, 10 minutes, etc.). For example, each 5 minute interval of a conference may be considered a section. In yet another embodiment, a user may (i.e., a conference leader) may pre-define certain conference segments and thereafter activate those segments during the conference.

An embodiment may also perform the segmentation of the online conference based upon the interactions between the presenter and the attendees or the attendees amongst themselves. In an embodiment, interactions with the conference may be detected by identifying how often certain users provide inputs (e.g., how often is a user's audio channel active, etc.) and/or the type of interactions a user has with the conference (e.g., questions, comments, etc.). For example, an embodiment may segment an online conference into three sections. The first section may correspond to a portion of the online conference where only the presenter's audio channel is active (e.g., the beginning of the conference where a conference leader is making the introductions and outlining the content to be discussed, etc.). The second section may correspond to a portion of the conference where an embodiment detects that multiple audio channels are either simultaneously active or are frequently active with respect to one another (e.g., indicating discussion of a topic, a question and answer period, etc.). The third section may correspond to a portion of the conference where substantially no audio channels are active (e.g., indicating a breakout session is occurring where groups are working on their own, etc.).

At 302, an embodiment may identify an engagement level for each of the sections. In the context of this application, an engagement level may be a reference for how interested, or engaged, a user may be with the online conference. In this regard, an attendee's engagement level may be gauged by identifying a number of interactions an attendee had with their device, the frequency with which the attendee had those interactions, a length of an attendee's inactivity with their device, the type of interactions with the conference (e.g., simple confirmations and salutations vs. substantive comments, etc.), a combination thereof, and the like. In an embodiment, the engagement level may be a quantitative value or, alternatively, may simply be a description of the foregoing criteria.

In an embodiment, additional information in the online conference may also be identified and presented to the user. For instance, an embodiment may identify, for each section, the percentage of time spent lecturing versus the percentage of time spent in discussion with the attendees. Additionally, in another embodiment, metadata associated with the conference may be obtained and tracked for each segment. For example, an embodiment may be able to identify the type of media presented in each section (e.g., pictures, videos, etc.) and/or the ratio of media to text. In another example, an embodiment may be able to identify characteristics of text used in a presentation (e.g., the number of words in the text document, the font size, etc.).

Responsive to not identifying, at 302, an engagement level associated with at least one section, an embodiment may, at 303, take no additional action. Alternatively, an embodiment may provide a notification to a conference leader that engagement levels for one or more sections could not be identified. Conversely, responsive to identifying, at 302, an engagement level associated with at least one section, an embodiment may, at 304, formulate a report based on the identifications.

In an embodiment, the report may be representative of a single conference or, alternatively may comprise information associated with two or more conferences. In an embodiment, the report may be a simple report that reports the engagement levels in each section of the conference. More particularly, as an example, the report may comprise information as to the number of engaged attendees per section, how long each attendee was engaged for, the number of attendees providing input in each section, etc. Such information may give a conference leader an informative, macro view of the conference.

An embodiment may also provide a user with deeper analytical information that may relate to more specific circumstances or situations in the conference. For example, an embodiment may identify that the engagement level across all sections was increased when media was being presented in a section vs. when just text was being presented. As another example, an embodiment may identify that the engagement level was increased in situations where there was greater discussion between attendees as opposed to situations where only the conference leader spoke. In yet another example, an embodiment may be able to identify that the attendees were more engaged when the conference leaders lectured about a particular topic (e.g., current action plan, etc.) as opposed to another topics (e.g., policy discussion, etc.).

When monitoring and reporting on the engagement level of attendees over multiple conferences, an embodiment may provide a user with a trend report regarding how changes made to their presentation positively or negatively affected the outcome. For example, assuming a user gave the same, five-section presentation multiple times, an embodiment may be able to show the user, in the report, how an adjusted section affects the engagement levels of attendees with respect to the same section in the other presentations.

In an embodiment, the trend information may be presented to the user in one or more graphs. The graphs may provide the user with visualized versions of the engagement level trends in each section over a plurality of conferences. Additionally, the graphs may also list the exponential moving average (“EMA”) of the engagement level for each section. For example, if the engagement level for section three over the last five presentations varied widely up and down, the EMA of that level would make it clear what the trend actually is. Such information may help smooth out natural variations due to the changing meeting attendees.

In an embodiment, a suggestion or recommendation may be dynamically provided to the user for ways in which they may adjust their presentation to improve an engagement level of a section. For example, a conference leader approaches section two in live conference, an embodiment may provide the leader with a notification reminding the leader that attendees in the past have remained more engaged when the leader talks less in the upcoming segment and promotes more discussion among attendees.

The various embodiments described herein thus represent a technical improvement to conventional online conference presentation techniques. Using the techniques described herein, an embodiment may first segment an online conference into one or more sections. The segmenting may be conducted dynamically, without additional user input, and may be based upon one or more criteria (e.g., by presentations slides, by topic, by time interval, by types of user interactions, etc.). An embodiment may then identify an engagement level for attendees in each of the sections and thereafter formulate a report based on the identified engagement levels. The report may be presented to a user and may comprise a variety of different metrics associated with the identification of the engagement levels. The overall result of such a method is that it may allow a system to learn about a conference leader's habits as well as the engagement levels of dynamically identified sections of the conference in order to provide suggestions for improvement.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
segmenting an online conference into one or more sections;
identifying, using a processor, an engagement level for each of the one or more sections; and
formulating, based on the identifying, a report.

2. The method of claim 1, wherein the online conference comprises a slide based presentation and wherein each of the one or more sections is associated with a different slide.

3. The method of claim 1, wherein each of the one or more sections is associated with a different topic.

4. The method of claim 1, wherein the segmenting comprises segmenting based upon a time interval.

5. The method of claim 1, wherein the segmenting comprises segmenting based upon a type of user interaction with the online conference.

6. The method of claim 1, wherein the identifying the engagement level comprises identifying a number of user interactions with the online conference in each of the one or more sections.

7. The method of claim 1, wherein the identifying comprises identifying additional conference metrics selected from the group consisting of a lecturing percentage, a discussion percentage, media characteristics, and text characteristics.

8. The method of claim 1, wherein the report comprises a trend graph.

9. The method of claim 1, wherein the report presents the engagement level with respect to an interaction ratio between the conference leader of the online conference and at least one other attendee in the online conference.

10. The method of claim 1, further comprising providing, prior to the beginning of a section of the one or more sections, a notification to a user describing an optimal engagement method for the section.

11. An information handling device, comprising:
a processor;
a memory device that stores instructions executable by the processor to:
segment an online conference into one or more sections;
identify an engagement level for each of the one or more actions; and
formulate, based on the identifying, a report.

12. The information handling device of claim 11, wherein the online conference comprises a slide based presentation and wherein each of the one or more sections is associated with a different slide.

13. The information handling device of claim 11, wherein each of the one or more sections is associated with a different topic.

14. The information handling device of claim 11, wherein the instructions executable by the processor to segment comprise instructions executable by the processor to segment based upon a time interval.

15. The information handling device of claim 11, wherein the instructions executable by the processor to segment comprise instructions executable by the processor to segment based upon a type of user interaction with the online conference.

16. The information handling device of claim 11, wherein the instructions executable by the processor to identify the engagement level comprise instructions executable by the processor to identify a number of user interactions with the online conference in each of the one or more sections.

17. The information handling device of claim 11, wherein the instructions executable by the processor to identify comprise instructions executable by the processor to identify additional conference metrics selected from the group consisting of a lecturing percentage, a discussion percentage, media characteristics, and text characteristics.

18. The information handling device of claim 11, wherein the report presents the engagement level with respect to an interaction ratio between the conference leader of the online conference and at least one other attendee in the online conference.

19. The information handling device of claim 11, wherein the instructions are further executable by the processor to provide, prior to the beginning of a section of the one or more sections, a notification to a user describing an optimal engagement method for the section.

20. A product, comprising:
a storage device that stores code, the code being executable by a processor and comprising:
code that segments an online conference into one or more sections;
code that identifies an engagement level for each of the one or more sections; and
code that formulates, based on the identifying, a report.
